(19) United States
(12) Patent Application Publication
(10) Pub. No.: US 2026/0281332 A1
(43) Pub. Date: Sep. 17, 2026

(54) Method and Apparatus of Adaptive Interpolation Filtering in Video Coding System

(71) Applicant: MEDIATEK INC., Hsinchu City (TW)

(72) Inventors: Yu-Cheng LIN, Hsinchu City (TW); Shih-Chun Chiu, Hsinchu City (TW); Yu-Ling HSIAO, Hsinchu City (TW); Tzu-Der CHUANG, Hsinchu City (TW); Chih-Wei HSU, Hsinchu City (TW); Ching-Yeh CHEN, Hsinchu City (TW); Yi-Wen CHEN, San Jose, CA (US); Yu-Wen HUANG, Hsinchu City (TW)

(21) Appl. No.: 19/472,650

(22) PCT Filed: May 11, 2024
(86) PCT No.: PCT/CN2024/092530

§ 371 Date: Oct. 4, 2025

Related U.S. Application Data
(60) Provisional application No. 63/501,694, filed on May 12, 2023.
(60) Provisional application No. 63/579,968, filed on Sep. 1, 2023.
(60) Provisional application No. 63/602,681, filed on Nov. 27, 2023.

(51) Int. Cl. H04N 19/117; H04N 19/105; H04N 19/109; H04N 19/132; H04N 19/139; H04N 19/156; H04N 19/176; H04N 19/182; H04N 19/503; H04N 19/70; H04N 19/80

(52) U.S. Cl. CPC H04N 19/117; H04N 19/105; H04N 19/109; H04N 19/132; H04N 19/139; H04N 19/156; H04N 19/176; H04N 19/182; H04N 19/503; H04N 19/70; H04N 19/80

(57) ABSTRACT

A method and apparatus adaptive interpolation filtering are disclosed. According to the method, input data comprising a current block or subblock are received, wherein the input data correspond to pixel data to be encoded at a video encoder side or the input data correspond to a coded data to be decoded at a video decoder side, and wherein the current block or subblock is coded in an intra mode, inter mode, or non-intra mode. An interpolation filter list comprising multiple interpolation filters is determined. The multiple interpolation filters in the interpolation filter list are reordered to form a reordered interpolation filter list. A target interpolation filter is selected from the reordered interpolation filter list. The target interpolation filter is applied to the current block or subblock to generate an interpolated block or subblock. The interpolated block or subblock is provided.

### CROSS REFERENCE TO RELATED APPLICATIONS

The present invention is a Non-Provisional Application of and claims priority to U.S. Provisional Patent Application No. 63/501,694, filed on May 12, 2023, U.S. Provisional Patent Application No. 63/579,968, filed on Sep. 1, 2023 and U.S. Provisional Patent Application No. 63/602,681, filed on Nov. 27, 2023. The U.S. Provisional Patent Applications are hereby incorporated by reference in their entireties.

### FIELD OF THE INVENTION

The present invention relates to video coding system. In particular, the present invention relates to applying interpolation filter adaptively to video data at a block or subblock level during coding process.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Some new tools relevant to the present invention are reviewed as follows.

### Inter Prediction in VVC

For each inter-predicted CU, motion parameters consist of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified, whereby the motion parameters for the current CU are obtained from neighbouring CUs, including spatial and temporal candidates, and additional schedules introduced in VVC. The merge mode can also be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### Extended Merge Prediction in VVC

In VVC, the merge candidate list is constructed by including the following five types of candidates in order:
1) Spatial Motion Vector Prediction (MVP) from spatial neighbouring CUs
2) Temporal MVP (TMVP) from collocated CUs
3) History-based MVP (HMVP) from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### Spatial Candidate Derivation

The derivation of spatial merge candidates in VVC is the same as that in HEVC except that the positions of first two merge candidates are swapped. A maximum of four merge candidates (B₀, A₀, B₁ and A₁) for current CU 210 are selected among candidates located in the positions depicted in FIG. 2. The order of derivation is B₀, A₀, B₁, A₁ and B₂. Position B₂ is considered only when one or more neighbouring CU of positions B₀, A₀, B₁, A₁ are not available (e.g. belonging to another slice or tile) or is intra coded. After candidate at position A₁ is added, the addition of the remaining candidates is subject to a redundancy check which ensures that candidates with the same motion information are excluded from the list so that coding efficiency is improved. To reduce computational complexity, not all possible candidate pairs are considered in the mentioned redundancy check. Instead, only the pairs linked with an arrow in FIG. 3 are considered and a candidate is only added to the list if the corresponding candidate used for redundancy check does not have the same motion information.

### Temporal Candidates Derivation

In this step, only one candidate is added to the list. Particularly, in the derivation of this temporal merge candidate for a current CU 410, a scaled motion vector is derived based on the co-located CU 420 belonging to the collocated reference picture as shown in FIG. 4. The reference picture list and the reference index to be used for the derivation of the co-located CU is explicitly signalled in the slice header. The scaled motion vector 430 for the temporal merge candidate is obtained as illustrated by the dotted line in FIG. 4, which is scaled from the motion vector 440 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 5. If CU at position C₀ is not available, is intra coded, or is outside of the current row of CTUs, position C₁ is used. Otherwise, position C₀ is used in the derivation of the temporal merge candidate.

### History-Based Merge Candidates Derivation in VVC

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (i.e., emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates can be used in the merge candidate list construction process. The latest several HMVP candidates in the table are checked in order and inserted to the candidate list after the TMVP candidate. Redundancy check is applied on the HMVP candidates with respect to the spatial or temporal merge candidate.

To reduce the number of redundancy, check operations, the following simplifications are introduced:
1. The last two entries in the table are checked for redundancy with respect to A₁ and B₁ spatial candidates, respectively.
2. Once the total number of available merge candidates reaches the maximally allowed merge candidates minus 1, the merge candidate list construction process from HMVP is terminated.

### Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; and if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

### Merge Estimation Region

Merge estimation region (MER) allows independent derivation of merge candidate list for the CUs in the same merge estimation region (MER). A candidate block that is within the same MER as the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel), and where (xCb, yCb) is the top-left luma sample position of the current CU in the picture and (cbWidth, cbHeight) is the CU size. The MER size is selected at the encoder side and signalled as log 2_parallel_merge_level_minus2 in the Sequence Parameter Set (SPS).

### High Precision ( 1/16 Pel) Motion Compensation and Motion Vector Storage in VVC

VVC increases the MV precision to 1/16 luma sample, to improve the prediction efficiency of slow motion video. This higher motion accuracy is particularly helpful for video contents with locally varying and non-translational motion such as in case of affine mode. For fractional position samples generation of higher MV accuracy, HEVC's 8-tap luma interpolation filters and 4-tap chroma interpolation filters are extended to 16 phases for luma and 32 phases for chroma. This extended filter set is applied in MC process of inter coded CUs except the CUs in affine mode. For affine mode, a set of 6-tap luma interpolation filter with 16 phases is used for lower computational complexity as well as memory bandwidth saving.

In VVC, the highest precision of explicitly signalled motion vectors for non-affine CU is quarter-luma-sample. In some inter prediction modes such as the affine mode, motion vectors can be signalled at 1/16-luma-sample precision. In all inter coded CU with implicitly inferred MVs, the MVs are derived at 1/16-luma-sample precision and motion compensated prediction is performed at 1/16-sample-precision. In terms of internal motion field storage, all motion vectors are stored at 1/16-luma-sample precision.

For temporal motion field storage used by TMVP and SbTMVP, motion field compression is performed at 8×8 size granularity in contrast to the 16×16 size granularity in HEVC.

Merge Mode with MVD (MMVD)

In addition to the merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected (referred as a base merge candidate in this disclosure), it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.

Distance index specifies motion magnitude information and indicates the pre-defined offset from the starting points (612 and 622) for a L0 reference block 610 and L1 reference block 620. As shown in FIG. 6 an offset is added to either horizontal component or vertical component of the starting MV, where small circles in different styles correspond to different offsets from the centre. The relation of distance index and pre-defined offset is specified in Table 1.

TABLE 1
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent the four directions as shown in Table 2. It is noted that the meaning of MVD sign could be variant according to the information of starting MVs. When the starting MVs are an un-prediction MV or bi-prediction MVs with both lists pointing to the same side of the current picture (i.e. POCs of two references both larger than the POC of the current picture, or both smaller than the POC of the current picture), the sign in Table 2 specifies the sign of the MV offset added to the starting MV. When the starting MVs are bi-prediction MVs with the two MVs pointing to the different sides of the current picture (i.e. the POC of one reference larger than the POC of the current picture, and the POC of the other reference smaller than the POC of the current picture), and the difference of POC in list 0 is greater than the one in list 1, the sign in Table 2 specifies the sign of MV offset added to the list0 MV component of the starting MV and the sign for the list1 MV has an opposite value. Otherwise, if the difference of POC in list 1 is greater than list 0, the sign in Table 2 specifies the sign of the MV offset added to the list1 MV component of starting MV and the sign for the list0 MV has an opposite value.

The MVD is scaled according to the difference of POCs in each direction. If the differences of POCs in both lists are the same, no scaling is needed. Otherwise, if the difference of POC in list 0 is larger than the one in list 1, the MVD for list 1 is scaled, by defining the POC difference of L0 as td and POC difference of L1 as tb, described in FIG. 4. If the POC difference of L1 is greater than L0, the MVD for list 0 is scaled in the same way. If the starting MV is uni-predicted, the MVD is added to the available MV.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 12-Tap Interpolation Filter in ECM

The 8-tap interpolation filter used in VVC is replaced with a 12-tap filter. The interpolation filter is derived from the sinc function of which the frequency response is cut off at Nyquist frequency and cropped by a cosine window function. Table 1 gives the filter coefficients of all 16 phases. FIG. 7 compares the frequency responses of the interpolation filters with the VVC interpolation filter, all at half-pel phase.

TABLE 1
Filter coefficients of the 12-tap interpolation filter

| | | | | | | | | | | | | |
|---|---|---|---|---|---|---|---|---|---|---|---|---|
| 1/16 | −1 | 2 | −3 | 6 | −14 | 254 | 16 | −7 | 4 | −2 | 1 | 0 |
| 2/16 | −1 | 3 | −7 | 12 | −26 | 249 | 35 | −15 | 8 | −4 | 2 | 0 |
| 3/16 | −2 | 5 | −9 | 17 | −36 | 241 | 54 | −22 | 12 | −6 | 3 | −1 |
| 4/16 | −2 | 5 | −11 | 21 | −43 | 230 | 75 | −29 | 15 | −8 | 4 | −1 |
| 5/16 | −2 | 6 | −13 | 24 | −48 | 216 | 97 | −36 | 19 | −10 | 4 | −1 |
| 6/16 | −2 | 7 | −14 | 25 | −51 | 200 | 119 | −42 | 22 | −12 | 5 | −1 |
| 7/16 | −2 | 7 | −14 | 26 | −51 | 181 | 140 | −46 | 24 | −13 | 6 | −2 |
| 8/16 | −2 | 6 | −13 | 25 | −50 | 162 | 162 | −50 | 25 | −13 | 6 | −2 |
| 9/16 | −2 | 6 | −13 | 24 | −46 | 140 | 181 | −51 | 26 | −14 | 7 | −2 |
| 10/16 | −1 | 5 | −12 | 22 | −42 | 119 | 200 | −51 | 25 | −14 | 7 | −2 |
| 11/16 | −1 | 4 | −10 | 19 | −36 | 97 | 216 | −48 | 24 | −13 | 6 | −2 |
| 12/16 | −1 | 4 | −8 | 15 | −29 | 75 | 230 | −43 | 21 | −11 | 5 | −2 |
| 13/16 | −1 | 3 | −6 | 12 | −22 | 54 | 241 | −36 | 17 | −9 | 5 | −2 |
| 14/16 | 0 | 2 | −4 | 8 | −15 | 35 | 249 | −26 | 12 | −7 | 3 | −1 |
| 15/16 | 0 | 1 | −2 | 4 | −7 | 16 | 254 | −14 | 6 | −3 | 2 | −1 |

For chroma interpolation additional longer 6-tap filters are used. The coefficients of filters are tabulated in Table 2.

TABLE 2
The coefficients of the 6-tap interpolation
filter for chroma components.

| Fractional position | Coefficients (6 taps) |
|---|---|
| 1/32 | {0, 0, 256, 0, 0, 0}, |
| 2/32 | {1, −6, 256, 7, −2, 0}, |
| 3/32 | {2, −11, 253, 15, −4, 1}, |
| 4/32 | {3, −16, 251, 23, −6, 1}, |
| 5/32 | {4, −21, 248, 33, −10, 2}, |
| 6/32 | {5, −25, 244, 42, −12, 2}, |
| 7/32 | {7, −30, 239, 53, −17, 4}, |
| 8/32 | {7, −32, 234, 62, −19, 4}, |
| 6/32 | {8, −35, 227, 73, −22, 5}, |
| 7/32 | {9, −38, 220, 84, −26, 7}, |
| 8/32 | {10, −40, 213, 95, −29, 7}, |
| 9/32 | {10, −41, 204, 106, −31, 8}, |
| 10/32 | {10, −42, 196, 117, −34, 9}, |
| 11/32 | {10, −41, 187, 127, −35, 8}, |
| 12/32 | {11, −42, 177, 138, −38, 10}, |
| 13/32 | {10, −41, 168, 148, −39, 10}, |
| 14/32 | {10, −40, 158, 158, −40, 10}, |
| 15/32 | {10, −39, 148, 168, −41, 10}, |
| 16/32 | {10, −38, 138, 177, −42, 11}, |
| 17/32 | {8, −35, 127, 187, −41, 10}, |
| 18/32 | {9, −34, 117, 196, −42, 10}, |
| 19/32 | {8, −31, 106, 204, −41, 10}, |
| 20/32 | {7, −29, 95, 213, −40, 10}, |
| 21/32 | {7, −26, 84, 220, −38, 9}, |
| 22/32 | {5, −22, 73, 227, −35, 8}, |
| 23/32 | {4, −19, 62, 234, −32, 7}, |
| 24/32 | {4, −17, 53, 239, −30, 7}, |
| 25/32 | {2, −12, 42, 244, −25, 5}, |
| 26/32 | {2, −10, 33, 248, −21, 4}, |
| 27/32 | {1, −6, 23, 251, −16, 3}, |
| 28/32 | {1, −4, 15, 253, −11, 2}, |
| 31/32 | {0, −2, 7, 256, −6, 1}, |

### 4-Tap Interpolation Filter and Reference Sample Smoothing

Four-tap intra interpolation filters are utilized to improve the directional intra prediction accuracy. In HEVC, a two-tap linear interpolation filter has been used to generate the intra prediction block in the directional prediction modes (i.e., excluding Planar and DC predictors). In VVC, the two sets of 4-tap IFs replace lower precision linear interpolation as in HEVC, where one is a DCT-based interpolation filter (DCTIF) and the other one is a 4-tap smoothing interpolation filter (SIF). The DCTIF is constructed in the same way as the one used for chroma component motion compensation in both HEVC and VVC. The SIF is obtained by convolving the 2-tap linear interpolation filter with [1 2 1]/4 filter.

Depending on the intra prediction mode, the following reference samples processing is performed:
The directional intra-prediction mode is classified into one of the following groups:
   Group A: vertical or horizontal modes (HOR_IDX, VER_IDX),
   Group B: directional modes that represent non-fractional angles (−14, −12, −10, −6, 2, 34, 66, 72, 76, 78, 80,) and Planar mode,
   Group C: remaining directional modes;
If the directional intra-prediction mode is classified as belonging to group A, then no filters are applied to reference samples to generate predicted samples;
Otherwise, if a mode falls into group B and the mode is a directional mode, and all of following conditions are true, then a [1, 2, 1] reference sample filter may be applied (depending on the MDIS (Mode Dependent Intra Smoothing) condition) to reference samples to further copy these filtered values into an intra predictor according to the selected direction, but no interpolation filters are applied:
   refIdx is equal to 0 (no MRL (Multiple Reference Lines))
   TU size is greater than 32
   Luma
   No ISP block
Otherwise, if a mode is classified as belonging to group C, MRL index is equal to 0, and the current block is not ISP (Intra Sub-Partition) block, then only an intra reference sample interpolation filter is applied to reference samples to generate a predicted sample that falls into a fractional or integer position between reference samples according to a selected direction (no reference sample filtering is performed). The interpolation filter type is determined as follows:
   Set minDistVerHor equal to Min(Abs(predModeIntra−50), Abs(predModeIntra−18) )
   Set nTbS equal to (Log 2 (W)+Log 2 (H))>>1
   Set intraHorVerDistThres[nTbS] as specified below:

| | nTbS = 2 | nTbS = 3 | nTbS = 4 | nTbS = 5 | nTbS = 6 | nTbS = 7 |
|---|---|---|---|---|---|---|
| intraHorVerDistThres[nTbS] | 24 | 14 | 2 | 0 | 0 | 0 |

If minDistVerHor is greater than intraHorVerDistThres[nTbS], SIF is used for the interpolation
Otherwise, DCTIF is used for the interpolation

In the present invention, methods and apparatus of adaptive interpolation filtering are disclosed in order to improve performance.

### BRIEF SUMMARY OF THE INVENTION

A method and apparatus for adaptive interpolation filtering are disclosed. According to the method, input data comprising a current block or subblock are received, wherein the input data correspond to pixel data to be encoded at a video encoder side or the input data correspond to a coded data to be decoded at a video decoder side, and wherein the current block or subblock is coded in an intra mode, inter mode, or non-intra mode. An interpolation filter list comprising multiple interpolation filters is determined. The multiple interpolation filters in the interpolation filter list are reordered to form a reordered interpolation filter list. A target interpolation filter is selected from the reordered interpolation filter list. The target interpolation filter is applied to the current block or subblock to generate an interpolated block or subblock. The interpolated block or subblock is provided.

In one embodiment, the multiple interpolation filters in the interpolation filter list are reordered in an ascending order or descending order according to cost metrics associated with the multiple interpolation filters. In one embodiment, the target interpolation filter has a smallest cost metric among the multiple interpolation filters.

In one embodiment, the cost metrics are derived using a process comprising template-matching, boundary-matching, or bilateral matching, or derived based on previously coded samples or information, neighbouring samples or information, and/or the current block or subblock. In one embodiment, the cost metrics are derived based on block-level template matching by generating reference templates of the current block or subblock using the multiple interpolation filters, and the cost metrics are calculated based on the reference templates of the current block or subblock respectively. In another embodiment, the cost metrics are derived based on block-level boundary matching by generating predictors of a block or subblock using the multiple interpolation filters, and the cost metrics are respectively calculated based on the predictors of the first block or subblock. In yet another embodiment, the cost metrics are derived based on block-level bilateral matching by generating predictor pairs of the current block or subblock using filter pairs from the multiple interpolation filters, and the cost metrics are respectively calculated based on the predictor pairs.

In one embodiment, the cost metrics are derived based on reference samples of the current block or subblock. In one embodiment, the cost metrics are derived based on statistics in a region of the reference samples. In one embodiment, the statistics comprise mean, variance, gradient, or a combination thereof.

In one embodiment, the interpolation filter list is constructed per block, subblock, affine subblock, or DMVR (Decoder-Side Motion Vector Refinement) subblock. In one embodiment, an index is signalled or parsed, or is inferred to indicate the target interpolation filter selected from the interpolation filter list. In one embodiment, a syntax element is signalled or parsed to indicate whether the target interpolation filter selected from the interpolation filter list is applied to the current block or subblock, and the index is signalled or parsed only when the syntax element is signalled or parsed to indicate the target interpolation filter being applied to the current block or subblock.

In one embodiment, the interpolation filter list is constructed using interpolation filter information associated with one or more previously coded blocks.

In one embodiment, the interpolation filter list comprises short-tap interpolation filter, long-tap interpolation filter, diagonal interpolation filter or anti-diagonal interpolation filter, or a combination thereof.

In one embodiment, the interpolation filter list includes inter-prediction modes comprising translational interpolation filter, affine interpolation filter, RPR (Reference Picture Resampling) interpolation filters, or a combination thereof.

In one embodiment, when the current block or subblock is coded using DMVR (Decoder-side Motion Vector Refinement) coding tool, the target interpolation filter is selected from the interpolation filter list based on unrefined MV (Motion Vector) or refined MV in one or more DMVR stages.

In one embodiment, when the current block or subblock is coded using OBMC (Overlapped Block Motion Compensation) coding tool, an original interpolation filter is applied to the current block or subblock instead of the target interpolation filter.

In one embodiment, the interpolation filter list comprises 12-tap interpolation filter, 8-tap interpolation filter, RPR (Reference Picture Resampling) interpolation filters, 6-tap interpolation filter, or a combination thereof.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates the neighbouring blocks used for deriving spatial merge candidates for VVC.

FIG. 3 illustrates the possible candidate pairs considered for redundancy check in VVC.

FIG. 4 illustrates an example of temporal candidate derivation, where a scaled motion vector is derived according to POC (Picture Order Count) distances.

FIG. 5 illustrates the position for the temporal candidate selected between candidates C₀ and C₁.

FIG. 6 illustrates the distance offsets from a starting MV in the horizontal and vertical directions according to Merge Mode with MVD (MMVD).

FIG. 7. shows the frequency responses of the 12-tap interpolation filter and the VVC interpolation filter at half-pel phase.

FIG. 8 illustrates an example of block-level template matching metric to determine the interpolation filter from the interpolation filter list.

FIG. 9 illustrates an example of block-level boundary matching metric to determine the interpolation filter from the interpolation filter list.

FIG. 10 illustrates a flowchart of an exemplary video coding system that selects an interpolation filter adaptively according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve the coding performance of interpolation, various schemes related to designing an interpolation filter list and selecting an interpolation filter adaptively are disclosed.

Conventionally, fixed 8-tap or fixed 12-tap interpolation filter is used for blocks coded in inter-prediction mode. However, fixed interpolation filter design might not be beneficial for various video content or different objects. An adaptive interpolation filtering method is proposed. In the proposed method, for each block or each subblock in a CTU, picture, or video sequence, different kinds of interpolation filter may be applied, including but not limited to, 8-tap interpolation filter in VVC, 12-tap interpolation filter in ECM, affine 6-tap interpolation filter, RPR (Reference Picture Resampling) 8-tap interpolation filter, affine RPR 6-tap interpolation filter, and so on. In order to determine the interpolation filter used for subblocks or blocks, some metrics are considered, including but not limited to, template matching, boundary matching, SSE (Sum of Squared Errors) cost, SAD (Sum of Absolute Differences) cost, SATD (Sum of Absolute Transformed Differences) cost, difference cost, predictor difference. The selected interpolation filter can be determined implicitly or explicitly by signalling. The signalling can be per block, per CTU, per picture, per sequence.

### Adaptive Interpolation Filter Design

In the proposed method, multiple interpolation filters are considered during motion compensation stage or interpolation stage. Possible interpolation filters can be from inter-prediction mode, intra-prediction mode, or IBC prediction mode. The number of taps in multiple interpolation filters can vary from 2-tap to 2N-taps, where N is an integer larger than or equal to 1.

In one embodiment, multiple interpolation filters are from inter-prediction modes, including but not limited to, translational interpolation filter, affine interpolation filter, or RPR interpolation filters for different scaling factors.

In another embodiment, multiple interpolation filters are from intra-prediction modes, including but not limited to, regular intra angular prediction interpolation filter (cubic, Gaussian, Gaussian2) or intra reference sample smoothing filter.

In another embodiment, multiple interpolation filters are from IBC-prediction modes.

In another embodiment, all possible interpolation filters from inter-prediction and intra-prediction are considered for adaptive interpolation filtering.

In another embodiment, all possible interpolation filters from inter-prediction and intra-prediction and IBC prediction mode are considered in adaptive interpolation filtering.

In another embodiment, the multiple interpolation filters for the adaptive interpolation filtering can be 2-tap, 4-tap, 6-tap, 8-tap, 10-tap, 12-tap and so on.

In another embodiment, finer granularity is considered in multiple interpolation filters, for example, 1/32-pel precision or 1/64-pel precision.

### Adaptive Interpolation Filter Selection

In order to determine the selected interpolation filter among all possible interpolation filters for adaptive interpolation filtering, some metrics are considered, including but not limited to, template matching, boundary matching, SSE cost, SAD cost, SATD cost, difference cost, predictor difference, and inheritance from reference samples. The metrics can be colour component-level, subblock-level, block-level, CTU-level, picture-level, video sequence-level and so on.

In one embodiment, block-level template matching is used to determine the interpolation filter, as shown in FIG. 8. Different interpolation filter is used to generate reference template and template matching cost is calculated. The interpolated reference template with the smallest cost is selected and the corresponding interpolation filter is used to generate current block's predictor. In FIG. 8, the structure of a current CU 812 and templates (814 and 816) is shown in drawing 810. The interpolated reference templates processed by 12-tap filter 820, 8-tap filter 830 and RPR filter 840 are shown in FIG. 8.

In another embodiment, CTU-level template matching is used to determine the interpolation filter. Different interpolation filter is used to generate reference template of a CTU and template matching cost is calculated. The interpolated reference template of a CTU with the smallest cost is selected and the corresponding interpolation filter is used to generate all predictors inside a CTU.

In another embodiment, block-level template matching is used to determine the interpolation filter. Different interpolation filters are used to generate reference templates of the first block inside a CTU or a picture, and template matching costs are calculated. The interpolated reference template of the first block inside a CTU or a picture with the smallest cost is selected and the corresponding interpolation filter is used to generate all predictors inside a CTU or a picture.

In another embodiment, template matching-based decision can be applied to inter-prediction mode for interpolation filter decision.

In another embodiment, template matching-based decision can be applied to intra-prediction mode for interpolation filter decision.

In another embodiment, template matching-based decision can be applied to IBC prediction mode for interpolation filter decision.

In another embodiment, only some prediction modes use template matching-based decision to determine the interpolation filter decision. For example, merge mode, AMVP mode, affine mode, subblock mode, and other prediction modes can use fixed interpolation filter without adaptive interpolation filter changes.

In another embodiment, only sequences with some resolutions use template matching-based decision to determine the interpolation filter decision. For example, 480p, 720p, 2K or 4K video, and other resolution videos can use fixed interpolation filter without adaptive interpolation filter changes.

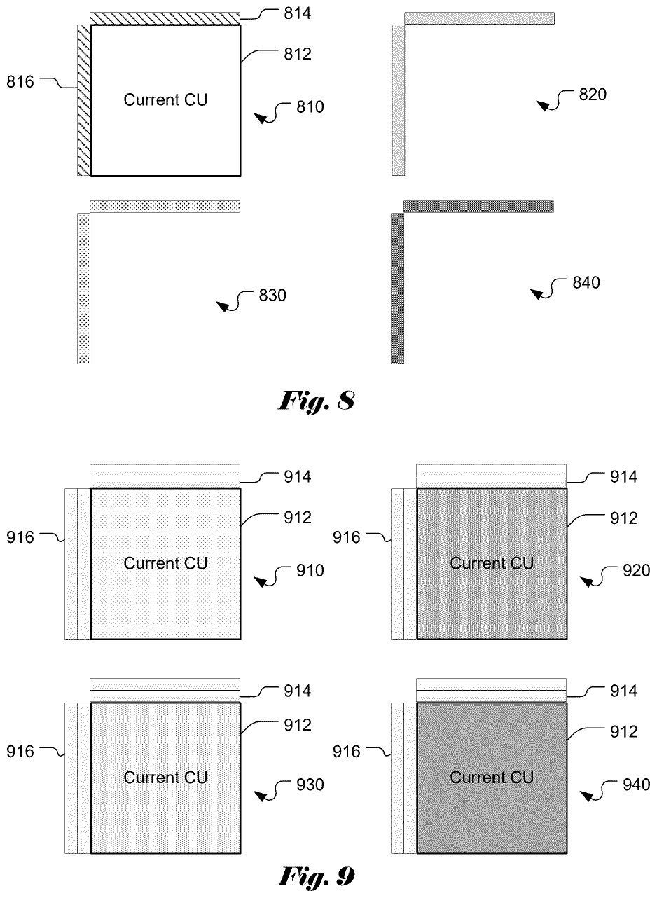

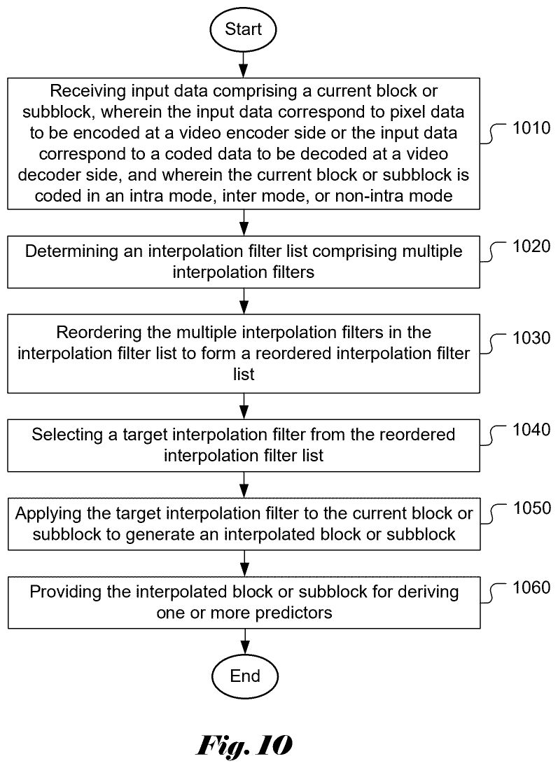

In another embodiment, block-level boundary matching is used to determine the interpolation filter, as shown in FIG. 9. Different interpolation filter is used to generate predictor for the current block or current subblock. Boundary matching cost is then calculated accordingly. The interpolated predictor with the smallest cost is selected and the corresponding interpolation filter is used to generate the predictor for the current block or current subblock. In FIG. 9, current CU 912 and templates (914 and 916) are shown. In FIG. 9, the current block is filtered by various filters including 12-tap filter 910, 8-tap filter 920, RPR filter 930, and 6-tap filter 940.

In another embodiment, CTU-level boundary matching is used to determine the interpolation filter. Different interpolation filters are used to generate predictors for a CTU, and boundary matching cost is calculated. The interpolated predictor of a CTU with the smallest cost is selected and the corresponding interpolation filter is used to generate all predictors inside a CTU.

In another embodiment, block-level boundary matching is used to determine the interpolation filter. Different interpolation filters are used to generate predictors of the first block inside a CTU or a picture, and boundary matching cost is calculated. The interpolated predictor of the first block inside a CTU or a picture with the smallest cost is selected and the corresponding interpolation filter is used to generate all predictors inside a CTU or a picture.

In another embodiment, subblock-level boundary matching is used to determine the interpolation filter. Different interpolation filter is used to generate current subblock's predictor and boundary matching cost is calculated. The boundary matching costs may involve one or more subblock boundaries. The interpolated predictor with the smallest cost is selected and the corresponding interpolation filter is used to generate current subblock's predictor.

In another embodiment, boundary matching-based decision can be applied to inter-prediction mode for interpolation filter decision.

In another embodiment, boundary matching-based decision can be applied to intra-prediction mode for interpolation filter decision.

In another embodiment, boundary matching-based decision can be applied to IBC prediction mode for interpolation filter decision.

In another embodiment, only some prediction modes use boundary matching-based decision to determine the interpolation filter decision. For example, merge mode, AMVP mode, affine mode, subblock mode, and other prediction modes can use fixed interpolation filter without adaptive interpolation filter changes.

In another embodiment, only some resolution sequences use boundary matching-based decision to determine the interpolation filter decision. For example, 480p, 720p, 2K or 4K resolution video, and other resolution videos can use fixed interpolation filter without adaptive interpolation filter changes.

In another embodiment, adaptive interpolation filtering is applied to only luma component.

In another embodiment, adaptive interpolation filtering is applied to only chroma component.

In another embodiment, adaptive interpolation filtering is selected according to interpolated predictor differences. The interpolated predictor differences can be variance inside interpolated predictors, luminance differences inside interpolated predictors, gradients inside interpolated predictors, or differences between non-interpolated reference samples and interpolated predictors. The interpolation filter with the smallest difference is treated as the selected interpolation filter for adaptive interpolation filtering, which can be applied to subblock-level, block-level, CTU-level, or picture-level. The differences can be absolute value, SAD, SATD or SSE.

In another embodiment, the adaptive interpolation filter can be inherited from reference samples. For example, when the BV or MV of the current block points to a reference block which uses 12-tap interpolation filter, the current block also inherits the selection of interpolation filter from the reference block.

### Signalling of Adaptive Interpolation Filter

In the proposed method, the signalling of the selected adaptive interpolation filter can be implicit or explicit. The signalling can be per subblock, per block, per CTU, per picture, per GOP, per video. In the proposed method, analysis can be performed firstly to determine the suitable interpolation filter among multiple interpolation filters and the selected interpolation filter is signalled.

In one embodiment, the selected interpolation filter for adaptive interpolation filtering is signalled per subblock, per block or per CTU or per picture or per GOP or per video.

In another embodiment, whole picture is pre-analyzed firstly, using different interpolation filters to generate predictors and computing costs, then the selected interpolation filter is signalled and the whole picture uses selected interpolation filter.

In another embodiment, each CTU is pre-analysed firstly, using different interpolation filters to generate predictors and computing costs, then the selected interpolation filter is signalled per CTU and the blocks inside the CTU uses selected interpolation filter.

In another embodiment, the selected interpolation filter flag is inferred by some other signals, including but not limited to, prediction modes, merge flag, subblock mode, affine mode, AMVP flag.

In another embodiment, adaptive interpolation filtering is mutually excluded with some prediction modes, such as subblock modes and affine mode.

### Constraint on Adaptive Interpolation Filter

In the proposed method, some constraints may be considered when adaptive interpolation filtering is applied. For example, all subblocks inside one block use the same selected interpolation filter, all blocks inside one CTU use the same selected interpolation filter, or all CTUs inside one picture use the same selected interpolation filter. In order to reduce the bandwidth, bi-prediction MVs may be converted to uni-prediction or fractional-pel precision MVs may be converted to integer-pel precision MVs. Padding may include subblock-level repetitive padding, block-level repetitive padding, CTU-level repetitive padding, or picture-level repetitive padding. The longest taps of adaptive interpolation filter cannot exceed the number of taps in the existing interpolation filter design.

In one embodiment, when adaptive interpolation filtering is considered, all subblocks inside one block use the same selected interpolation filter.

In another embodiment, when adaptive interpolation filtering is considered, all blocks inside one CTU use the same selected interpolation filter.

In another embodiment, when adaptive interpolation filter is considered, all CTUs inside one picture use the same selected interpolation filter.

In another embodiment, when adaptive interpolation filtering is considered, bi-prediction MVs are converted into uni-prediction MV.

In another embodiment, when adaptive interpolation filtering is considered, fractional-pel precision MVs are converted into integer-pel precision MVs.

In another embodiment, when adaptive interpolation filtering is applied to subblocks, subblock-level repetitive padding is used in reference sample interpolation.

In another embodiment, when adaptive interpolation filtering is applied to blocks, block-level repetitive padding is used in reference sample interpolation.

In another embodiment, when adaptive interpolation filtering is applied to blocks, CTU-level repetitive padding is used in reference sample interpolation.

In another embodiment, when adaptive interpolation filtering is applied to blocks, picture-level repetitive padding is used in reference sample interpolation.

### Adaptive Interpolation Filter Determination

Several adaptive interpolation filter determination methods are disclosed. In one proposed method, in bi-prediction block, interpolation filters for L0 and L1 can be the same or can be different.

In another proposed method, similar to switchable half-pel interpolation filter in VVC, when MV points to some fractional position and/or MV is in some precision (e.g., ¼-pel, 1/16-pel), adaptive interpolation filtering is allowed.

In another proposed method, after current block predictor generation, OBMC (Overlapped Block Motion Compensation) may be applied to refine the predictor. The interpolation filter used in the OBMC process may be inherited from a neighbouring block, the current block, or use a pre-defined or fixed interpolation filter.

In another proposed method, multi-pass DMVR (MP-DMVR) includes multi-passes MV refinement process, where DMVR refers to Decoder-Side Motion Vector Refinement. The unrefined MV, the intermediate refined MV, or the final refined MV can be used in the adaptive interpolation filtering.

In another proposed method, for current block, reference samples, motion vectors, reference templates, and/or current templates are used to determine the interpolation filter.

In another proposed method, the possible interpolation filters are reordered in an ascending or descending order according to some cost metrics, and the codec may select one of the reordered interpolation filters with the corresponding syntax design.

Adaptive Interpolation Filtering in Bi-prediction

In one embodiment, in bi-prediction, adaptive interpolation filtering is applied to L0 and L1 separately. That is, interpolation filters used in L0 and L1 may be different.

In another embodiment, in bi-prediction, adaptive interpolation filtering is applied to L0 and L1 jointly. That is, same interpolation filter is used in both L0 and L1.

In another embodiment, in bi-prediction, adaptive interpolation filtering is only allowed in one inter-prediction direction, such as L0 or in L1, while the other inter-prediction direction utilizes a pre-defined or fixed interpolation filter.

### Applicable Condition in Adaptive Interpolation Filtering

In one embodiment, when MV of the current block MV points to a fractional-pixel position, adaptive interpolation filtering is allowed at the current block. For example, the fractional-pixel position can be N/16 fractional-pixel positions N/4 fractional-pixel position or N/2 fractional pixel position, where N is an integer.

In another embodiment, when MV of the current block is in fractional MV resolution, adaptive interpolation filtering is allowed at the current block. For example, fractional MV resolution can be quarter-pel MV resolution or half-pel MV resolution.

In another embodiment, when MV, horizontal MV component, or vertical MV component is in some ranges, adaptive interpolation filtering is implicitly allowed. For example, when the horizontal MV component is close to an integer position, adaptive interpolation filtering is used in the horizontal direction. For another example, when the vertical MV component is far from an integer position, adaptive interpolation filtering is used in the horizontal direction.

In another embodiment, when diagonal or anti-diagonal interpolation is applied, the following horizontal or vertical interpolation depends on motion information or MV. For example, when the horizontal MV is close to a fractional-pixel position, the following interpolation is horizontal interpolation. For another example, when the vertical MV is far from a fractional-pixel position, the following interpolation is vertical interpolation.

### Adaptive Interpolation Filtering in OBMC

In one embodiment, in OBMC process, interpolation filter of neighbouring block is always used to perform MC to generate neighbouring predictors. The interpolation filter of neighbouring block can be one of the options from adaptive interpolation filtering.

In another embodiment, in OBMC process, interpolation filter of the current block is always used to perform MC to generate neighbouring predictors. The interpolation filter of the current block can be one of the options from adaptive interpolation filtering.

In another embodiment, in OBMC process, the interpolation filter used to perform MC to generate neighbouring predictors can be adaptively changed. The interpolation filter can be one of the options from adaptive interpolation filtering. For example, the interpolation filter for OBMC process can depend on characteristics of the current block, neighbouring block, or reference block or classification results.

In another embodiment, in OBMC process, a pre-defined or fixed interpolation filter is used to perform MC to generate neighbouring predictors, regardless of the adaptive interpolation filter.

### MV Usage in Refinement Process in Adaptive Interpolation Filtering

In one embodiment, for blocks coded in DMVR mode, unrefined MV is used in adaptive interpolation filtering.

In another embodiment, for blocks coded in DMVR mode, intermediate refined MV is used for adaptive interpolation filtering. For example, the intermediate refined MV can be the refined MV after the 1^{st} pass or the 2^{nd} pass in DMVR.

In another embodiment, for blocks coded in DMVR mode, the final refined MV is used in adaptive interpolation filtering. For example, the final refined MV can be the refined MV after all passes in DMVR.

In another embodiment, the MV usage in different prediction modes can be different for adaptive interpolation filtering. For example, an intermediate refined MV is used in merge mode and unrefined MV is used in AMVP mode. In another embodiment, a final refined MV is used in merge mode and intermediate refined MV is used in AMVP mode.

In another embodiment, for decoder complexity reduction, the unrefined MV is used for adaptive interpolation filtering.

In the above embodiments, MV is used for deriving whether to use adaptive interpolation filtering or which adaptive interpolation filter to use.

### Adaptive Interpolation Filter Selection

In one embodiment, reference samples are used to determine the interpolation filter. Statistics such as mean, variance, and/or gradient in a region of the reference samples are derived, and the interpolation filter is determined based on the statistics.

For example, there are multiple interpolation filters that interpolate along with different directions. For the current block, the gradients along with different directions of the reference block(s) are derived, and the interpolation filter is determined according to the gradient information.

For another example, there are multiple interpolation filters that have different number of filter taps. For the current block, the variances of the reference block(s) are derived, and the interpolation filter is determined according to the variance information.

In another embodiment, for bi-prediction blocks, reference samples from both sides are used to determine the interpolation filters by bilateral matching. The bilateral matching has been used in VVC to allow motion vector derivation at the decoder side by using reference pictures in both sides (i.e., reference picture lists L0 and L1). Specifically, given a pair of interpolation filters for both sides as a candidate, generate the predictors of both sides (i.e., predictor pairs) accordingly and calculate the bilateral matching cost. The final pair of interpolation filters is derived by taking the one with the lowest cost among all candidates.

In another embodiment, motion vectors are used to implicitly determine the interpolation filter, where different interpolation filters can be filters with different number of taps, or filters with different filtering directions.

Example: given four interpolation filter options A, B, C, and D, the fractional part of motion vector indicates the selection of interpolation filter.

If fractional part is { 0/16, 4/16, 8/16, 12/16}, select interpolation filter A.

If fractional part is { 1/16, 5/16, 9/16, 13/16}, select interpolation filter B.

If fractional part is { 2/16, 6/16, 10/16, 14/16}, select interpolation filter C.

If fractional part is { 3/16, 7/16, 11/16, 15/16}, select interpolation filter D.

In another embodiment, interpolation filter options are reordered by using the current and reference templates according to template matching (TM) costs or boundary matching (BM) costs, and the position of the selected interpolation filter in the reordered list is signalled.

In the above embodiments, regarding using reference samples, motion vectors, or templates (information related to motion vector) to select the interpolation filters, if decoder-side motion vector refinement is present, the interpolation filter selection can be based on unrefined motion vectors, intermediate refined motion vectors, or refined motion vectors.

### Reordering in Adaptive Interpolation Filtering—Reordering Methods

In one embodiment, one or more possible interpolation filters are reordered in one or more lists. The reordering is based on cost metrics, such as template matching costs, boundary matching costs, or bilateral matching costs. The reordered interpolation filter candidates can be in an ascending or descending order according to the cost metric.

In another embodiment, one or more reordered lists for uni-prediction and one or more reordered lists for bi-prediction are used. The numbers of reordered candidates in these lists can be the same or different, but the numbers of reordered candidates in these lists cannot exceed the number of corresponding maximum possible interpolation filters. For example, if there are 5 interpolation filters available, the maximum number of possible interpolation filters for uni-prediction is 5, while the maximum number of possible interpolation filters for bi-prediction is 25.

In another embodiment, for bi-prediction, there are two reordered lists for both sides, and the lists are derived separately.

In another embodiment, for bi-prediction, there is only one reordered list, and the list is derived by jointly considering both sides. In this embodiment, a candidate in the reordered list is a pair of interpolation filter selections.

In another embodiment, original horizontal/vertical interpolation filter is excluded in the reordered list. In another embodiment, original horizontal/vertical interpolation filter is considered in the reordered list.

In another embodiment, only a subset of possible interpolation filters is considered in the reordered list. The number of the considered interpolation filters can be the same for uni-prediction and bi-prediction, or different for uni-prediction and bi-prediction.

### Reordering in Adaptive Interpolation Filtering—Reordering Syntax Design

In the reordered interpolation filter syntax design, the codeword can be truncated unary or truncated Rice. In the truncated Rice design, the reordered candidates are divided into several groups. Group index will be signalled or inferred, and candidate index in the selected group will be signalled or inferred.

In one embodiment, as shown in Table 5, one on/off flag or enable/disable flag is signalled or inferred to determine whether original horizontal/vertical interpolation filter is used or not. Truncated unary codeword is used to select the reordered interpolation filter candidate in the list.

In another embodiment, similar to Table 5, the original horizontal/vertical interpolation filter is also considered in the reordered list, and truncated unary codeword is used to select the reordered interpolation filter candidate in the list.

In another embodiment, as shown in Table 6, one on/off flag or enable/disable flag is signalled or inferred to determine whether original horizontal/vertical interpolation filter is used or not. Truncated Rice codeword is used to select the reordered interpolation filter candidate in the list. In this example, 16 reordered candidates are divided evenly into 4 groups. A group index will be signalled or inferred, and 2 bypass bins are signalled or inferred to indicate the selected candidate in the group.

In another embodiment, similar to Table 6, the original horizontal/vertical interpolation filter is also considered in the reordered list. Truncated Rice codeword is used to select the reordered interpolation filter candidate in the list. A group index will be signalled or inferred and one or more bypass bins are signalled or inferred to indicate the selected candidate in the group.

In another embodiment, each group can contain different number of reordered candidates. For example, group 0 contains 1 candidate, group 1 contains 2 candidates, group 2 contains 4 candidates and so on. Different number of bypass bins is used to indicate the candidates in the selected group.

In another embodiment, each group can contain non-power-of 2 number of reordered candidates. For example, some groups contain 3 candidates and other groups contain 5 candidates.

TABLE 5
Example of truncated unary codeword used in reordered list

| Filter Selection | On/off Flag | Candidate Index |
|---|---|---|
| Hor/ver | 0 | |
| | 1 | 0 |
| Reordered 1^{st} Candidate | | |
| | 1 | 10 |
| Reordered 2^{nd} Candidate | | |
| | 1 | 110 |
| Reordered 3^{rd} Candidate | | |
| | 1 | 111 |
| Reordered 4^{th} Candidate | | |

TABLE 6
Example of truncated rice codeword used in reordered list

| Filter Selection | On/off Flag | Group Index | Candidate Index |
|---|---|---|---|
| Hor/ver | 0 | N/A | N/A |
| Reordered 1^{st} Candidate | 1 | 0 | 00 |
| Reordered 2^{nd} Candidate | 1 | 0 | 01 |
| Reordered 3^{rd} Candidate | 1 | 0 | 10 |
| Reordered 4^{th} Candidate | 1 | 0 | 11 |
| Reordered 5^{th} Candidate | 1 | 10 | 00 |
| Reordered 6^{th} Candidate | 1 | 10 | 01 |
| Reordered 7^{th} Candidate | 1 | 10 | 10 |
| Reordered 8^{th} Candidate | 1 | 10 | 11 |
| Reordered 9^{th} Candidate | 1 | 110 | 00 |
| Reordered 10^{th} Candidate | 1 | 110 | 01 |
| Reordered 11^{th} Candidate | 1 | 110 | 10 |
| Reordered 12^{th} Candidate | 1 | 110 | 11 |
| Reordered 13^{th} Candidate | 1 | 111 | 00 |
| Reordered 14^{th} Candidate | 1 | 111 | 01 |
| Reordered 15^{th} Candidate | 1 | 111 | 10 |
| Reordered 16^{th} Candidate | 1 | 111 | 11 |

### Bilateral Matching in Adaptive Filter Selection

In the proposed method, bilateral matching is used in adaptive filter selection. Bilateral matching can be performed at block-level or subblock-level. Bilateral-matching-based filter selection may be applied to those blocks coded with DMVR mode or other prediction modes, such as BM merge.

Bilateral-matching-based filter selection may use unrefined MVs, intermediate refined MVs, or final refined MVs in DMVR mode. The cost metrics used in bilateral matching can be SATD, SAD, or SSE between generated L0 predictor and generated L1 predictor.

In one embodiment, bilateral matching is performed at block-level to select the interpolation filter. The MVs used in bilateral matching can be unrefined MV at block-level, refined MV at block-level, or representative MV at block-level. The representative MV can be the averaged subblock-level MV or most appeared subblock-level MV.

In another embodiment, bilateral matching is performed at subblock-level to select the interpolation filter. The MVs used in bilateral matching can be unrefined MV at block-level, refined MV at subblock-level, refined MV at subblock-level, or representative MV. The representative MV can be the averaged subblock-level MV or most appeared subblock-level MV.

In another embodiment, all subblocks inside one block may have their own interpolation filter selection using bilateral matching. In another embodiment, only some subblocks inside one block may have their own interpolation filter selection, such as top CU boundary subblocks or left CU boundary subblocks.

In another embodiment, subblocks may have the constraint that same interpolation filter is used in L0 and L1 in bi-prediction. In another embodiment, subblocks may choose different interpolation filter used in L0 and L1 in bi-prediction.

In another embodiment, cost metrics used in bilateral matching-based can be SAD, SATD, or SSE between generated L0 predictor and L1 generated predictor. The generated L0 predictor and generated L1 predictor can be at subblock-level or block-level.

### Improvements of Adaptive Interpolation Filter Selection

Some methods for improving adaptive interpolation filter selection are disclosed.

### Adaptive Interpolation Filter (AIF)

Given a currently coded region, some explicit and/or implicit methods are used to select an interpolation filter from a set of interpolation filters, where the set of interpolation filters can be different in terms of filter coefficients, number of taps, or filter footprints. The selected interpolation filter is used to generate the reconstructed samples in the coded region. The region can be a picture, sub-picture, slice, tile, CTU, CU, subblock in CU, or single sample.

If the adaptive interpolation filter is selected per subblock in CU, the subblock size can be the same or different from motion unit size.

In the following description, a default interpolation filter is referred to as “non-adaptive interpolation filter (non-AIF),” while other interpolation filter options are referred to as “adaptive interpolation filters (AIFs).”

### Filter Selection by MV

In one embodiment, based on the horizontal or vertical component of MV, all or partial of the AIFs are implicitly or explicitly disallowed.

### Example 1

Non-AIF is horizontal filtering followed by vertical filtering, and ATFs are non-horizontal and non-vertical filtering followed by horizontal or vertical filtering. Specifically, given a current sample and an MV, an AIF first interpolates some intermediate samples by taking the neighbouring samples of the current sample along with a direction, which is neither horizontal nor vertical, and interpolates a final sample by performing a horizontal or vertical filtering with the intermediate samples. In such design, there are two groups of AIFs:
Group 1 AIFs: non-horizontal and non-vertical filtering followed by horizontal filtering
Group 2 AIFs: non-horizontal and non-vertical filtering followed by vertical filtering

If the horizontal component of the MV is an integer, Group 2 AIFs are disallowed; while if the vertical component of the MV is an integer, Group 1 AIFs are disallowed.

In another embodiment, based on the MV difference between the current block and a neighbouring block, AIF for current block is selected.

### Example 2

Non-AIF is horizontal filtering followed by vertical filtering, and AIFs are diagonal or anti-diagonal filtering followed by horizontal or vertical filtering. Given a current block, an MV difference between the current block and a neighbouring block is calculated. If the direction of the MV difference is close to horizontal or vertical direction, non-AIF is used for the current block; otherwise, AIF is used for the current block.

### Filter Selection in GPM

In one embodiment, an AIF index is signalled for a GPM block, or two AIF indexes are signalled for two partitions of the GPM block.

In the above embodiment, when an AIF index is signalled for a GPM block, the non-AIF one is the shortest one, and/or the AIF ones are all the same length.

In above embodiment, when two AIF indexes are signalled for two partitions of a GPM block, the signalling can be separate or joint signalling. That is, separately signal an AIF index for partition 0 and another AIF index for partition 1, or jointly signal an index for both partitions.

In the above embodiment, when joint signalling is used, the index of indicating non-AIF for two partitions is the shortest, and/or the indexes of indicating individual partitions are the second shortest. Or the index of indicating non-AIF for two partitions is the shortest, and/or the indexes of indicating two partitions have the same AIF index are the second shortest.

In the above embodiment, an AIF index is inferred by GPM partition mode (angle and distance), GPM-MMVD flags, GPM-TM flags, GPM-INTRA flags, and/or GPM blending index. The inferred rule is predefined or is signalled in the bitstream.

In another embodiment, a blending process is applied to the GPM partition by blending a predictor with AIF index and a predictor without AIF index.

### Example 3

Perform motion compensation with AIF index for partition 0 and/or partition 1
Perform motion compensation without AIF index for partition 0 and/or partition 1
Perform blending process to a predictor with AIF index and a predictor without AIF index for partition 0 and/or partition 1
Perform original GPM blending process, that is blending predictors of partition 0 and partition 1

In the above embodiment, the blending process and/or blending weights is related to GPM partition mode (angle and distance), GPM-MMVD flags, GPM-TM flags, GPM-INTRA flags, and/or GPM blending index.

In the above embodiment, the blending process of blending a predictor with AIF index and a predictor without AIF index is only applied to the weighted area in the original GPM blending process.

### Filter Selection in Affine

In one embodiment, based on the affine model (control point MVs) of the current block, the AIF selection of each subblock inside the current block is determined by the affine model.

### Example 4

Similar to Example 2, the MV difference between two subblocks is calculated, where the subblock MVs are derived from the affine model. The direction of the MV difference is used to determine which interpolation filter is used for the current subblock.

### Filter Selection by Bilateral Matching

In one embodiment, non-AIF is used in L0, and L1 may select a possible AIF index.

In another embodiment, non-AIF is used in L1, and L0 may select a possible AIF index.

In another embodiment, cost of non-AIF is reduced during bilateral matching to be more preferable, similar to VVC DMVR.

In another embodiment, cost of AIF is increased during bilateral matching to guarantee that the selection of interpolation filter is more suitable.

In another embodiment, AIF subblock size or unit is the same as the motion unit size. For example, the AIF subblock size is 4×4 and the motion unit size is also 4×4.

In another embodiment, AIF subblock size or unit is different from the motion unit size. For example, the AIF subblock size is 4×4 and the motion unit size is 8×8.

In another embodiment, one or more parameters in the following group will be inherited from the current block in bilateral matching for AIF selection, including LIC parameters, interpolation filter type (signalled index or flag, or inferred), BCW index, BDOF type, DMVR type, GEO type, template matching type, CIIP type, MMVD type and MMVD index, OOB (Out-of-Boundary) type, AMVP-merge type, and IBC type.

In another embodiment, one or more parameters in the following group will be disabled in bilateral matching for AIF selection, including LIC parameters, interpolation filter type (signalled index or flag, or inferred), BCW index, BDOF type, DMVR type, GEO type, template matching type, CIIP type, MMVD type and MMVD index, OOB (Out-of-Boundary) type, AMVP-merge type, and IBC type.

In another embodiment, one or more parameters in the following group will be inherited from the current block in bilateral matching for AIF selection, including, MV, integer MV, affine model, affine motion, control-point MVs, inter-prediction direction (for example, uni-prediction List0, uni-prediction List1, bi-prediction), and merge index

In another embodiment, one or more parameters in the following group will be disabled in bilateral matching for AIF selection, including MV, integer MV, affine model, affine motion, control-point MVs, inter-prediction direction (e.g. uni-prediction List0, uni-prediction List1, or bi-prediction), merge index

In the above embodiments, bilateral matching can be applied to both DMVR and non-DMVR coded blocks (i.e., all bi-predicted blocks).

Integration with DMVR

In the following embodiments, the usage of interpolation filter is considered in the process of DMVR

In one embodiment, when refining the MV using bilateral matching in DMVR process, not only different MVs are tested, but also different AIF settings (may include non-AIF) are tested. The DMVR process outputs the MV and the AIF setting that jointly provide the best bilateral matching cost.

In another embodiment, when refining the MV using bi-directional optical flow (BDOF) in DMVR process, given N AIF settings (may include non-AIF), N optical flows are estimated from N interpolated results, and N BDOF refinement results are generated. The DMVR process outputs the best BDOF refinement results, containing the best refined MV, the best refined sample values, and the best AIF setting.

In the above embodiments, if bilateral matching direction (bmdir) is set, MV of one side would be fixed and the refinement would only be applied to the other side. In such case, the AIF setting is also fixed for the MV-fixed side, and different AIF settings are only tested for the other side.

### Filter Selection by Previously Coded Blocks

In one embodiment, AIF is selected for the current block based on previously coded blocks. Specifically, an AIF setting is derived by using the information of previously coded blocks, such as the reference samples of the blocks, the predictors of the blocks, and/or the reconstruction of the blocks.

### Example 5

Given a current block, determine a previously coded block, fetch the reference samples and the reconstructed samples of the previously coded block, and apply different AIF settings to the reference samples to generate multiple predictors. The matching costs between the predictors and the reconstructed samples are calculated and used for selecting the best AIF setting. The selected best AIF setting is used for coding the current block.

### Filter Coefficient and Input Sample Selection

In one embodiment, AIF is applied to a current block, where the filter coefficients and/or the input samples of the interpolation are selected by the fractional parts of the MV of the current block.

### Example 6

AIF is diagonal filtering. Let the fractional parts of the current MV be (xfrac, yfrac). The filter coefficients are selected by xfrac (or yfrac), while the input samples are determined by the integer part of the MV and refined by the fractional part of the MV. Specifically, the input samples are derived from the integer-MV-pointed reference samples, but if xfrac is larger (or smaller) than yfrac, the integer-MV-pointed position is left/right-shifted (or up/down-shifted) to select a different set of reference samples as the input samples of interpolation.

### Example 7

AIF is anti-diagonal filtering. The filter coefficient selection is the same as Example 6. The input samples are derived from the integer-MV-pointed reference samples, but if (xfrac+yfrac) is larger (or smaller) than one integer pel, the integer-MV-pointed position is left/right-shifted (or up/down-shifted) to select a different set of reference samples as the input samples of interpolation.

In another embodiment, AIF is applied to a current block and is multi-stage interpolation, where the filter coefficients and/or the input samples of each stage are selected by the fractional parts of the MV of the current block, and the selection methods of different stages can be different.

### Example 8

AIF is diagonal (or anti-diagonal) filtering followed by vertical (or horizontal) filtering. Let the fractional parts of the current MV be (xfrac, yfrac). For the first stage (i.e., diagonal filtering), similar to Example 6, the filter coefficients are selected by xfrac (or yfrac), while the input samples are refined by (xfrac, yfrac). For the second stage, the filter coefficients are selected by the sum (or the difference) of xfrac and yfrac, and the input samples are derived from the interpolated results from the first stage.

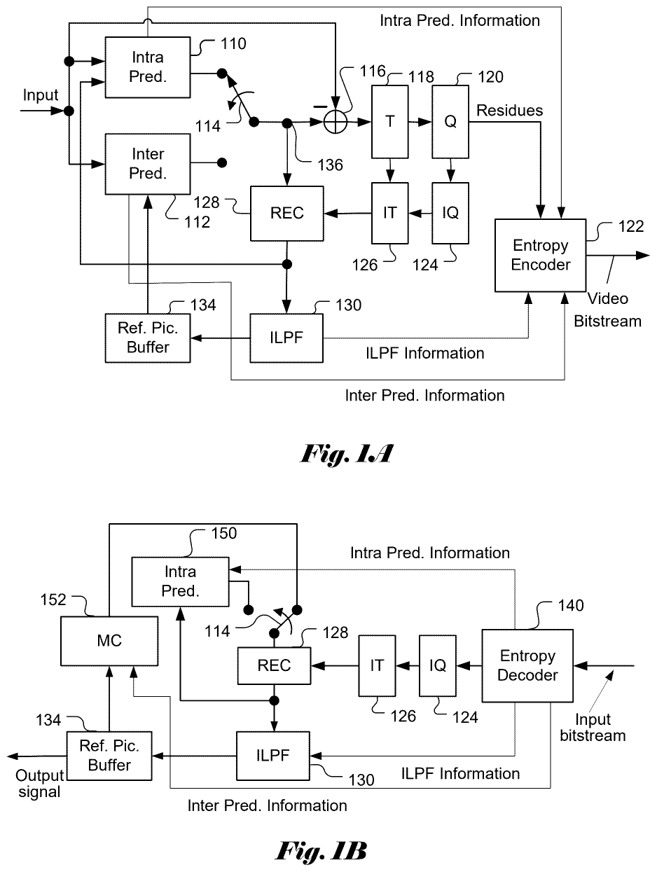

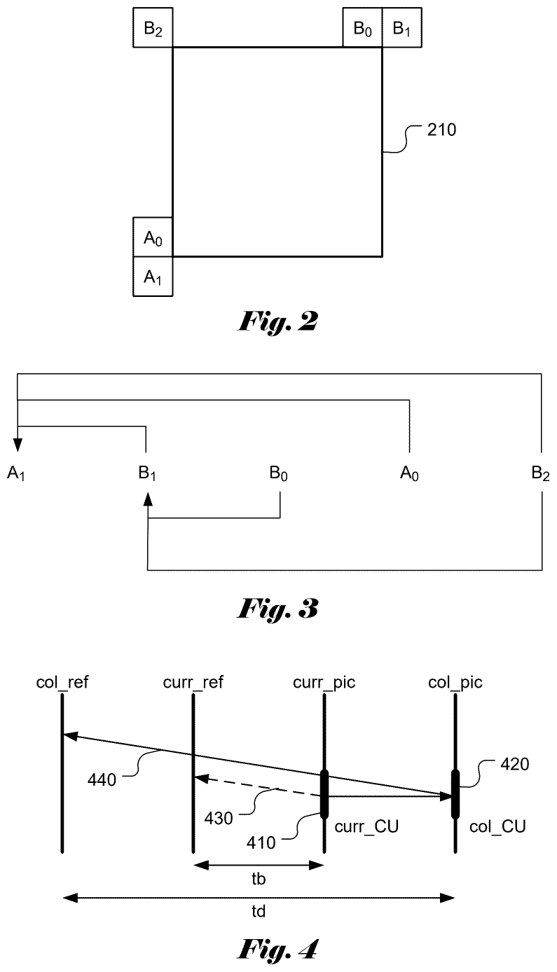

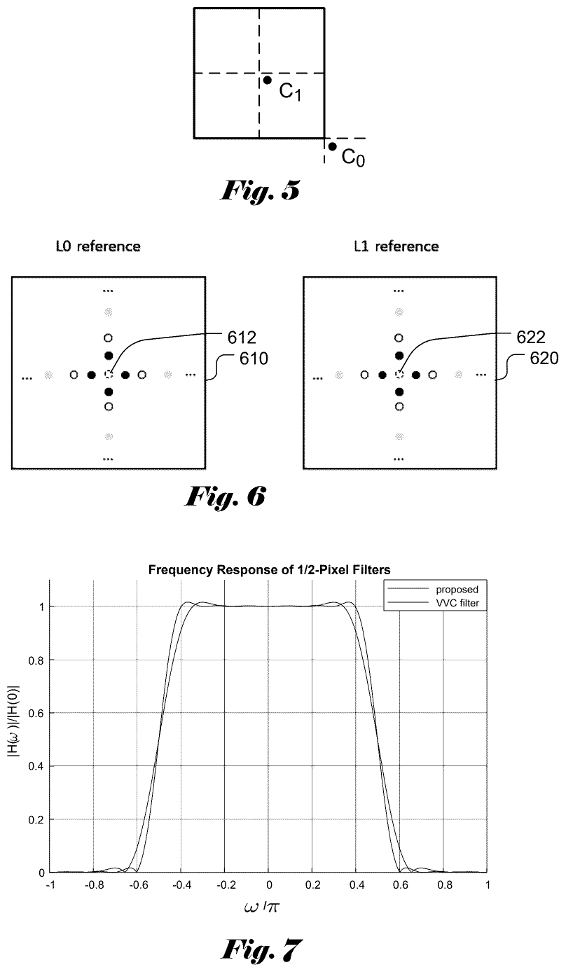

Any of the foregoing proposed adaptive interpolation filtering methods can be implemented in encoders and/or decoders. For example, any of the proposed methods can be implemented in predictor derivation module of an encoder, and/or a predictor derivation module of a decoder. Alternatively, any of the proposed methods can be implemented as a circuit coupled to the predictor derivation module of the encoder and/or the predictor derivation module of the decoder, so as to provide the information needed by the predictor derivation module. Alternatively, any of the proposed methods can be implemented as circuits coupled to the inter/intra prediction modules of the encoder and/or the inter/intra prediction modules of the decoder, so as to provide the information needed by the inter/intra prediction modules. For example, a coding system using adaptive interpolation filtering methods can be implemented in the reference encoder/decoder in FIGS. 1A-B. For example, any of the adaptive interpolation filtering methods can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed adaptive interpolation filtering derivation methods can also be implemented as a circuit coupled to the intra/inter coding module at the decoder or the encoder. However, the decoder or encoder may also use additional processing unit to implement the required adaptive interpolation filtering processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 10 illustrates a flowchart of an exemplary video coding system that selects an interpolation filter adaptively according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data comprising a current block or subblock are received in step 1010, wherein the input data correspond to pixel data to be encoded at a video encoder side or the input data correspond to a coded data to be decoded at a video decoder side, and wherein the current block or subblock is coded in an intra mode, inter mode, or non-intra mode. An interpolation filter list comprising multiple interpolation filters is determined in step 1020. The multiple interpolation filters in the interpolation filter list are reordered to form a reordered interpolation filter list in step 1030. A target interpolation filter is selected from the reordered interpolation filter list in step 1040. The target interpolation filter is applied to the current block or subblock to generate an interpolated block or subblock in step 1050. The interpolated block or subblock is provided for deriving one or more predictors in step 1060.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data comprising a current block or subblock, wherein the input data correspond to pixel data to be encoded at a video encoder side or the input data correspond to a coded data to be decoded at a video decoder side, and wherein the current block or subblock is coded in an intra mode, inter mode, or non-intra mode;
determining an interpolation filter list comprising multiple interpolation filters;
reordering the multiple interpolation filters in the interpolation filter list to form a reordered interpolation filter list;
selecting a target interpolation filter from the reordered interpolation filter list;
applying the target interpolation filter to the current block or subblock to generate an interpolated block or subblock; and
providing the interpolated block or subblock for deriving one or more predictors.

2. The method of claim 1, wherein the multiple interpolation filters in the interpolation filter list are reordered in an ascending order or descending order according to cost metrics associated with the multiple interpolation filters.

3. The method of claim 2, wherein the target interpolation filter has a smallest cost metric among the multiple interpolation filters.

4. The method of claim 2, wherein the cost metrics are derived using a process comprising template-matching, boundary-matching, or bilateral matching, or derived based on previously coded samples or information, neighbouring samples or information, and/or the current block or subblock.

5. The method of claim 4, wherein the cost metrics are derived based on block-level template matching by generating reference templates of the current block or subblock using the multiple interpolation filters, and the cost metrics are calculated based on the reference templates of the current block or subblock respectively.

6. The method of claim 4, wherein the cost metrics are derived based on block-level boundary matching by generating predictors of a target block or subblock using the multiple interpolation filters, and the cost metrics are respectively calculated based on the predictors of the target block or subblock.

7. The method of claim 4, wherein the cost metrics are derived based on block-level bilateral matching by generating predictor pairs of the current block or subblock using filter pairs from the multiple interpolation filters, and the cost metrics are respectively calculated based on the predictor pairs.

8. The method of claim 4, wherein the cost metrics are derived based on reference samples of the current block or subblock.

9. The method of claim 8, wherein the cost metrics are derived based on statistics derived for a region of the reference samples.

10. The method of claim 9, wherein the statistics comprise mean, variance, gradient, or a combination thereof.

11. The method of claim 1, wherein the interpolation filter list is constructed per block, subblock, affine subblock, or DMVR (Decoder-Side Motion Vector Refinement) subblock.

12. The method of claim 1, wherein an index is signalled or parsed, or is inferred to indicate the target interpolation filter selected from the interpolation filter list.

13. The method of claim 12, wherein a syntax element is signalled or parsed to indicate whether the target interpolation filter selected from the interpolation filter list is applied to the current block or subblock, and the index is signalled or parsed only when the syntax element is signaled or parsed to indicate the target interpolation filter being applied to the current block or subblock.

14. The method of claim 1, wherein the interpolation filter list is constructed using interpolation filter information associated with one or more previously coded blocks.

15. The method of claim 1, wherein the interpolation filter list comprises short-tap interpolation filter, long-tap interpolation filter, diagonal interpolation filter or anti-diagonal interpolation filter, or a combination thereof.

16. The method of claim 1, wherein the interpolation filter list includes inter-prediction modes comprising translational interpolation filter, affine interpolation filter, RPR (Reference Picture Resampling) interpolation filters, or a combination thereof.

17. The method of claim 1, wherein when the current block or subblock is coded using DMVR (Decoder-side Motion Vector Refinement) coding tool, the target interpolation filter is selected from the interpolation filter list based on unrefined MV (Motion Vector) or refined MV in one or more DMVR stages.

18. The method of claim 1, wherein when the current block or subblock is coded using OBMC (Overlapped Block Motion Compensation) coding tool, an original interpolation filter is applied to the current block or subblock instead of the target interpolation filter.

19. The method of claim 1, wherein the interpolation filter list comprises 12-tap interpolation filter, 8-tap interpolation filter, RPR (Reference Picture Resampling) interpolation filters, 6-tap interpolation filter, or a combination thereof.

20. An apparatus of video coding, the apparatus comprising one or more electronic circuits or processors arranged to:
receive input data comprising a current block or subblock, wherein the input data correspond to pixel data to be encoded at a video encoder side or the input data correspond to a coded data to be decoded at a video decoder side, and wherein the current block or subblock is coded in an intra mode, inter mode, or non-intra mode;
determine an interpolation filter list comprising multiple interpolation filters;
reorder the multiple interpolation filters in the interpolation filter list to form a reordered interpolation filter list;
select a target interpolation filter from the reordered interpolation filter list;
apply the target interpolation filter to the current block or subblock to generate an interpolated block or subblock; and
provide the interpolated block or subblock for deriving one or more predictors.
